(19) United States
(12) Patent Application Publication
(10) Pub. No.: US 2023/0264720 A1
(43) Pub. Date: Aug. 24, 2023

(54) Autonomous Vehicle and Control Method Thereof

(71) Applicants: Hyundai Motor Company, Seoul (KR); Kia Corporation, Seoul (KR)

(72) Inventor: Dae Young Kim, Gwangmyeong-si (KR)

(21) Appl. No.: 17/948,661

(22) Filed: Sep. 20, 2022

(30) Foreign Application Priority Data
Feb. 21, 2022 (KR) 10-2022-0022516

(51) Int. Cl. B60W 60/00; B60W 50/16; B60W 30/12; B60W 30/18

(52) U.S. Cl. CPC B60W 60/0061; B60W 30/12; B60W 30/18163; B60W 50/16; B60W 60/0053; B60W 60/0059; B60W 2050/143

(57) ABSTRACT

An autonomous vehicle and a control method thereof are provided. The autonomous vehicle includes a processor that performs autonomous driving control of a vehicle. The processor deactivates a first driving assistance function, when activating an autonomous driving function, activates a driving safety function, when the autonomous driving function is deactivated during the autonomous driving control, and returns the first driving assistance function to a state before the autonomous driving function is activated.

### CROSS-REFERENCE TO RELATED APPLICATIONS

This application claims the benefit of Korean Patent Application No. 10-2022-0022516, filed on Feb. 21, 2022, which application is hereby incorporated herein by reference.

### TECHNICAL FIELD

The present disclosure relates to an autonomous vehicle and a control method thereof.

### BACKGROUND

An autonomous vehicle refers to a vehicle capable of recognizing driving environments without manipulation of its driver to determine a risk and planning a driving route to drive itself. An autonomous driving technology loaded into such an autonomous vehicle is divided into 6 stages from Level 0 to Level 5 according to the guideline (J3016) proposed by the Society of Automotive Engineers (SAE).

Various levels of autonomous driving technologies (autonomous driving functions) are applied to the autonomous vehicle at the same time. When an upper level of autonomous driving function (or an upper level function) includes a lower level of autonomous driving function (or a lower level function), the upper level function and the lower level function may not be operated at the same time. Furthermore, when the upper level function and the lower level function have different control regions, the upper level function may not include the lower level function or may include a portion of the lower level function. Even in this case, when the upper level function is activated, the lower level function is deactivated. Furthermore, after the lower level function is deactivated due to the activation of the upper level function, when the upper level function is deactivated, the lower level function may be maintained in an inactive state and a dangerous situation may occur.

### SUMMARY

The present disclosure has been made to solve the above-mentioned problems occurring in the prior art while advantages achieved by the prior art are maintained intact.

An aspect of the present disclosure provides an autonomous vehicle for providing cooperative control of a function having the same control range and a function having a different control function, when an autonomous driving function is activated, and a control method thereof.

Another aspect of the present disclosure provides an autonomous vehicle for reactivating deactivated functions when activating an autonomous driving function, when the autonomous driving function switches from an active state to an inactive state, and a control method thereof.

Another aspect of the present disclosure provides an autonomous vehicle for compulsorily activating a driving safety function, when the autonomous driving function is deactivated, and a control method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an autonomous vehicle may include a processor that performs autonomous driving control of a vehicle. The processor may deactivate a first driving assistance function, when activating an autonomous driving function, may activate a driving safety function, when the autonomous driving function is deactivated during the autonomous driving control, and may return the first driving assistance function to a state before the autonomous driving function is activated.

The autonomous driving function may include only functionality of the first driving assistance function or may include the first driving assistance function and a second driving assistance function and may fail to include a parking assistance function.

The processor may receive a command to instruct to activate the first driving assistance function, the second driving assistance function, or the parking assistance function and may output a notification indicating that it is impossible to activate the first driving assistance function, the second driving assistance function, or the parking assistance function depending on the received command.

The processor may switch an operation state of the second driving assistance function to a ready state when activating the autonomous driving function, when the autonomous driving function includes only functionality of the first driving assistance function, and may deactivate the parking assistance function.

The processor may receive a command to instruct to activate the second driving assistance function and may switch the operation state of the second driving assistance function from the ready state to an active state.

The processor may deactivate the second driving assistance function and the parking assistance function, when activating the autonomous driving function.

When the autonomous driving function is deactivated may be at least one of when there is no user response to a take-over request, when it is impossible to perform the autonomous driving control, or when a system determines to deactivate autonomous driving.

The processor may maintain activation of the driving safety function, before the autonomous driving function is deactivated by a user, when the user manipulates a steering device, a braking device, or an acceleration device, or during a predetermined specific time.

The processor may activate at least one driving safety function depending on a priority, when there are two or more driving safety functions.

The processor may maintain the autonomous driving function and the first driving assistance function in an inactive state, when the autonomous driving function is deactivated.

According to another aspect of the present disclosure, a control method of an autonomous vehicle may include deactivating a first driving assistance function, when activating an autonomous driving function, performing autonomous driving control in a state where the autonomous driving function is activated, activating a driving safety function, when the autonomous driving function is deactivated, and returning the first driving assistance function to a state before the autonomous driving function is activated, when the autonomous driving function is deactivated.

The autonomous driving function may include only functionality of the first driving assistance function or may include the first driving assistance function and a second driving assistance function and may fail to include a parking assistance function.

The performing of the autonomous driving control may include receiving a command to instruct to activate at least one of the first driving assistance function, the second driving assistance function, or the parking assistance function and outputting a notification indicating that it is impossible to activate the first driving assistance function, the second driving assistance function, or the parking assistance function depending on the received command.

The deactivating of the first driving assistance function may include switching an operation state of the second driving assistance function to a ready state, when the autonomous driving function includes only functionality of the first driving assistance function, and deactivating the parking assistance function.

The performing of the autonomous driving control may include receiving a command to instruct to activate the second driving assistance function and switching the operation state of the second driving assistance function from the ready state to an active state.

The deactivating of the first driving assistance function may include deactivating the second driving assistance function and the parking assistance function.

When the autonomous driving function is deactivated may be at least one of when there is no user response to a take-over request, when it is impossible to perform the autonomous driving control, or when a system determines to deactivate autonomous driving.

The compulsory activating of the driving safety function may include maintaining activation of the driving safety function, before the autonomous driving function is deactivated by a user, when the user manipulates a steering device, a braking device, or an acceleration device, or during a predetermined specific time.

The compulsory activating of the driving safety function may include activating at least one driving safety function depending on a priority, when there are two or more driving safety functions.

The control method may further include maintaining the autonomous driving function and the first driving assistance function in an inactive state, when the autonomous driving function is deactivated.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of an autonomous vehicle according to embodiments of the present disclosure;

FIG. 2 is a flowchart illustrating a control method of an autonomous vehicle according to an embodiment of the present disclosure;

FIG. 3 is a flowchart illustrating a method for controlling a driving assistance function during autonomous driving according to an embodiment of the present disclosure;

FIG. 4 is a flowchart illustrating a control method of an autonomous vehicle according to another embodiment of the present disclosure;

FIG. 5 is a flowchart illustrating an example of controlling a driving assistance function during autonomous driving according to another embodiment of the present disclosure;

FIG. 6 is a flowchart illustrating another example of controlling a driving assistance function during autonomous driving according to another embodiment of the present disclosure;

FIG. 7 is a flowchart illustrating a control method of an autonomous vehicle according to another embodiment of the present disclosure;

FIG. 8 is a flowchart illustrating a control method of an autonomous vehicle according to another embodiment of the present disclosure; and

FIG. 9 is a flowchart illustrating a method for controlling a driving assistance function during autonomous driving according to another embodiment of the present disclosure.

### DETAILED DESCRIPTION OF ILLUSTRATIVE EMBODIMENTS

Hereinafter, some embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

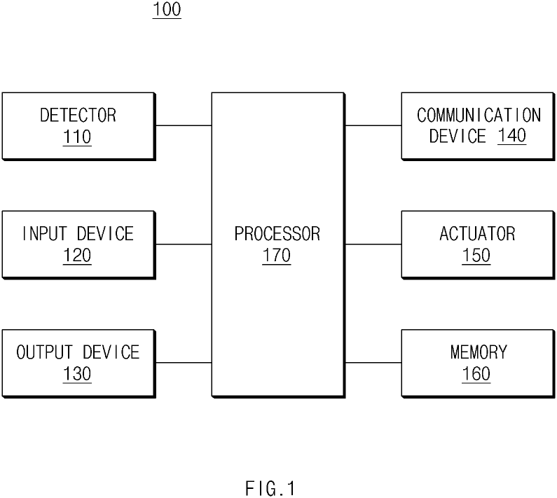

FIG. 1 is a block diagram illustrating a configuration of an autonomous vehicle according to embodiments of the present disclosure.

An autonomous vehicle 100 may be a vehicle loaded with an autonomous driving function, which may include at least one specific control function depending on an autonomous driving assistance level (i.e., levels of driving automation) of the vehicle. The specific control function may include smart cruise control (SCC), advanced SCC (ASCC), navigation SCC (NSCC), electronic stability control (ESC), lane departure warning (LDW), lane keeping assist (LKA), collision avoidance (CAS), driver status monitoring (DSM), highway driving assist (HDA), blind spot detection (BSD), autonomous emergency braking (AEB), traffic jam assist (TJA), and the like.

Referring to FIG. 1, the autonomous vehicle (hereinafter, referred to as a “vehicle”) 100 may include a detector 110, an input device 120, an output device 130, a communication device 140, an actuator 150, a memory 160, a processor 170, and the like.

The detector 110 may detect a line, an object, a vehicle location, and the like by means of various sensors. The detector 110 may recognize a line, an object, a vehicle location, and the like using a camera, a radio detecting and ranging (radar), a light detection and ranging (LiDAR), an ultrasonic sensor, an impact sensor, a speed sensor, a steering angle sensor, an acceleration sensor, a global positioning system (GPS), and the like.

The input unit 120 may generate input data according to manipulation of a user (e.g., a driver). The input device 120 may be implemented as a keyboard, a keypad, a button, a switch, a touch pad, a touch screen, and/or the like. For example, the input device 120 may generate a signal (or a command) to instruct to activate a specific function such as an autonomous driving function and a driving assistance function depending on a user input.

The output device 130 may display various pieces of information (e.g., a vehicle state, a notification, and a warning) on a display depending on a control command of the processor 170. The display may be implemented as at least one of display devices such as a liquid crystal display (LCD), a thin film transistor-liquid crystal display (TFT-LCD), an organic light-emitting diode (OLED) display, a flexible display, a three-dimensional (3D) display, a transparent display, a head-up display (HUD), a touch screen, and a cluster.

Furthermore, the output device 130 may output a notification, a warning, and/or the like under an instruction of the processor 170. The output device 130 may output an alarm sound, a warning sound, and/or the like stored in the memory 160 through a sound output device such as a speaker.

The communication device 140 may assist with performing communication between the vehicle 100 and an external device (e.g., a control server, another vehicle, a city infrastructure, and/or the like). The communication circuit 140 may use a communication technology such as a wireless Internet (e.g., Wi-Fi, wireless broadband (Wibro), or the like), mobile communication (e.g., long term evolution (LTE), code division multiple access (CDMA), or the like), and/or vehicle communication (e.g., vehicle to everything (V₂X)).

The actuator 150 may control acceleration, steering, braking, and the like of the vehicle 100. The actuator 150 may control an operation of the vehicle 100 depending on a control command transmitted from the processor 170. The actuator 150 may be driven by a combination of a plurality of control commands.

The memory 160 may be a non-transitory storage medium which stores instructions executed by the processor 170. The memory 160 may be implemented as at least one of storage media such as a flash memory, a hard disk, a secure digital (SD) card, a random access memory (RAM), a static RAM (SRAM), a read only memory (ROM), a programmable ROM (PROM), an electrically erasable and programmable ROM (EEPROM), and an erasable and programmable ROM (EPROM).

The processor 170 may control the overall operation of the vehicle 100. The processor 170 may be implemented as at least one of processing devices such as an application specific integrated circuit (ASIC), a digital signal processor (DSP), a programmable logic device (PLD), a field programmable gate array (FPGA), a central processing unit (CPU), a microcontroller, and/or a microprocessor.

The processor 170 may determine a current state of the vehicle 100 based on the information obtained by means of the detector 110. The processor 170 may output at least one control command for controlling an operation of the vehicle 100 depending on the determined current state. The processor 170 may output a control command for outputting an indication and a notification of the determined current state.

The processor 170 may output a control command to the actuator 150 and may provide an autonomous driving function without manipulation of the user for a steering device, a braking device, or an acceleration device. The autonomous driving function may include at least one of driving assistance functions such as a lane keeping function, a driving speed adjustment function, and a lane change function.

When receiving a command to instruct to activate the autonomous driving function from the input device 120, the processor 170 may activate the autonomous driving function. When receiving a command to instruct to deactivate the autonomous driving function from the input device 120, the processor 170 may deactivate the autonomous driving function. In other words, the processor 170 may switch an operation state of the autonomous driving function from an active state to an inactive state or from the inactive state to the active state, depending on the user input received from the input device 120.

The processor 170 may automatically deactivate the autonomous driving function in a state where the autonomous driving function is activated. When corresponding to at least one of when there is no a user response to a take-over request, when it is impossible to perform autonomous driving control, or when a system (or the autonomous driving function) determines to deactivate autonomous driving, the processor 170 may automatically switch the operation state of the autonomous driving function from the active state to the inactive state.

When activating the autonomous driving function, the processor 170 may deactivate a first driving assistance function. Herein, the first driving assistance function may be a function (e.g., a lane keeping function) included in the autonomous driving function. When activating the autonomous driving function, the processor 170 may switch (or transition) an operation state of a second driving assistance function to a ready state and may maintain the ready state. Herein, the second driving assistance function may be a function which is not included in the autonomous driving function (e.g., a lane change assistance function). When activating the autonomous driving function, the processor 170 may deactivate a parking assistance function.

The processor 170 may receive a command to instruct to activate at least one of the first driving assistance function, the second driving assistance function, or the parking assistance function in a state where the autonomous driving function is activated. In other words, the processor 170 may receive a function activation command for at least one of the first driving assistance function, the second driving assistance function, or the parking assistance function while performing the autonomous driving function. Although receiving the function activation command, the processor 170 may fail to activate the assistance function. For example, although receiving the function activation command for the lane keeping function during autonomous driving control, the processor 170 may fail to switch the autonomous driving function to the lane keeping function. The processor 170 may output a notification indicating that it is impossible to activate a function using the output device 130.

As another example, when receiving the function activation command for the second driving assistance function in a state where the autonomous driving function is activated, the processor 170 may switch the operation state of the second driving assistance function from the ready state to the active state. In other words, when a control command indicating activation of the second driving assistance function is received during autonomous driving control, the processor 170 may switch the autonomous driving function to the second driving assistance function.

When activating the autonomous driving function, the processor 170 may deactivate the first driving assistance function and may deactivate the second driving assistance function and the parking assistance function. Herein, the first driving assistance function and the second driving assistance function may be functions included in the autonomous driving function. The parking assistance function may be a function which is not included in the autonomous driving function. The processor 170 may receive a command to instruct to activate the first driving assistance function, the second driving assistance function, or the parking assistance function in the state where the autonomous driving function is activated. When receiving the function activation function, the processor 170 may fail to activate the first driving assistance function, the second driving assistance function, or the parking assistance function. The processor 170 may not activate a function and may output a notification indicating that it is impossible to activate the function through the output device 130.

When the autonomous driving function is automatically deactivated without intervention of the user while performing autonomous driving control, the processor 170 may compulsorily activate a driving safety function. The driving safety function may include at least one of safety assistance functions such as a lane keeping assist function (e.g., a lane following assist function or the like) and a collision-avoidance assist function (e.g., an emergency braking function or the like). As an example, the processor 170 may compulsorily activate at least one of safety assistance functions such as the collision-avoidance assist function and the lane keeping assist function. As another example, the processor 170 may sequentially and compulsorily activate the collision-avoidance assist function and the lane keeping assist function depending to priorities.

The processor 170 may maintain the driving safety function in the active state, immediately before the autonomous driving function is deactivated by the user, before the user manipulates a steering device (e.g., a steering wheel), a braking device (e.g., a brake pedal), or an acceleration device (e.g., an accelerator pedal), or during a predetermined specific time.

When the autonomous driving function is deactivated while performing autonomous driving control, the processor 170 may return to a state immediately before the autonomous driving function is activated. For example, when the autonomous driving function is deactivated, the processor 170 may automatically reactivate the driving assistance function, which is switched from the active state to the inactive state when activating the autonomous driving function. When the autonomous driving function is deactivated, the processor 170 may maintain both the autonomous driving function and the driving assistance function in the inactive state. In other words, when the user manually performs driving, the processor 170 may maintain operation state(s) of deactivated function(s) in the inactive state when activating the autonomous driving function.

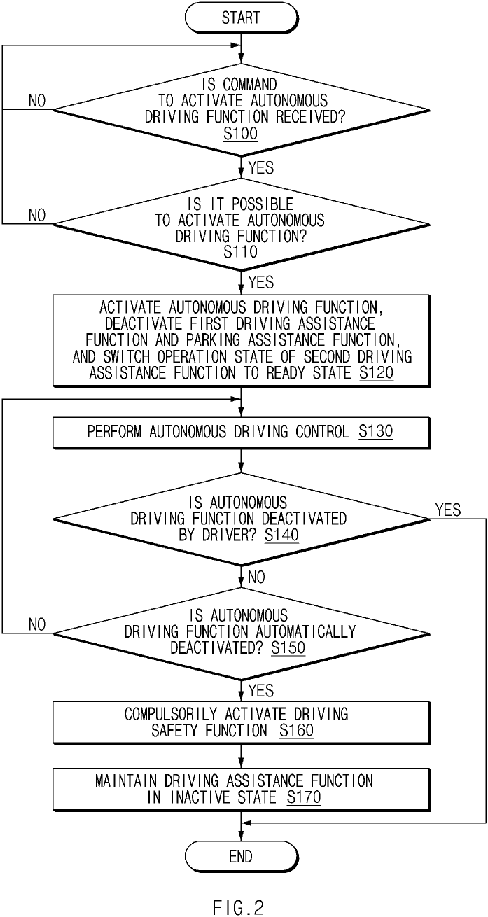

FIG. 2 is a flowchart illustrating a control method of an autonomous vehicle according to an embodiment of the present disclosure.

In S100, a processor 170 of FIG. 1 may identify whether a command to activate an autonomous driving function is received. The processor 170 may receive a control command (or a user input) to instruct to activate the autonomous driving function from an input device 120 of FIG. 1.

In S110, the processor 170 may determine whether it is possible to activate the autonomous driving function. The processor 170 may determine a vehicle state based on information obtained by a detector 110 of FIG. 1 and may determine whether it is possible to activate the autonomous driving function based on the determined result.

When it is determined that it is possible to activate the autonomous driving function, in S120, the processor 170 may activate the autonomous driving function, may deactivate a first driving assistance function and a parking assistance function, and may switch an operation state of a second driving assistance function to a ready state. The autonomous driving function may include the first driving assistance function and may fail to include the second driving assistance function and the parking assistance function.

When the autonomous driving function is activated, in S130, the processor 170 may perform autonomous driving control. The processor 170 may recognize a driving environment, a vehicle state, and the like by means of the detector 110 and may control autonomous driving of a vehicle 100 of FIG. 1 based on the recognized driving environment, the recognized vehicle state, and the like. The processor 170 may perform autonomous driving control using a well-known autonomous driving control technology. Thus, a detailed description of the autonomous driving control will be omitted in the specification.

In S140, the processor 170 may identify whether the autonomous driving function is deactivated by a driver while performing the autonomous driving control. The processor 170 may identify whether a command to instruct to deactivate the autonomous driving function is received from the input device 120 in the state where the autonomous driving function is activated.

When the autonomous driving function is not deactivated by the driver, in S150, the processor 170 may identify whether the autonomous driving function is automatically deactivated. When corresponding to at least one of when there is no user response to a take-over request, when it is impossible to perform the autonomous driving control, or when a system determines to deactivate autonomous driving, the processor 170 may deactivate the autonomous driving function.

When the autonomous driving function is automatically deactivated, in S160, the processor 170 may compulsorily activate a driving safety function. The driving safety function may include at least one of safety assistance functions such as a lane keeping assist function and a collision-avoidance assist function. When the driving safety function includes two or more safety assistance functions, the processor 170 may compulsorily activate at least one of the two or more safety assistance functions. The processor 170 may maintain the driving safety function in an active state, immediately before the autonomous driving function is deactivated by a user, before the user manipulates a steering device (e.g., a steering wheel), a braking device (e.g., a brake pedal), or an acceleration device (e.g., an accelerator pedal), or during a predetermined specific time.

After performing S160 or when the autonomous driving function is deactivated by the driver, in S170, the processor 170 may maintain operation states of the autonomous driving function, the first driving assistance function, and the parking assistance function in an inactive state. In other words, although the autonomous driving function is deactivated, the processor 170 may maintain the changed state when activating the autonomous driving function.

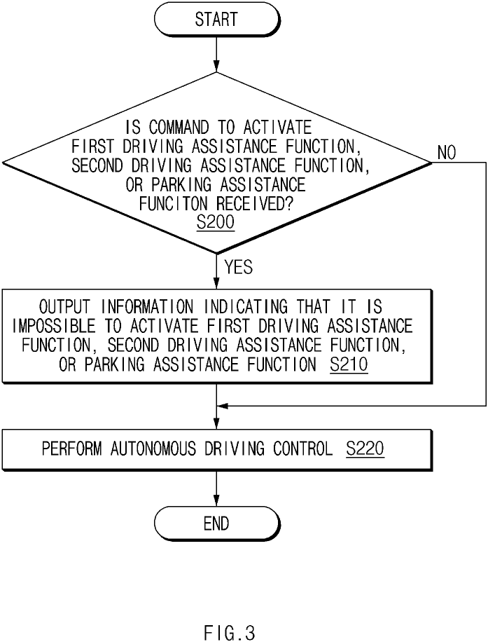

FIG. 3 is a flowchart illustrating a method for controlling a driving assistance function during autonomous driving according to an embodiment of the present disclosure. The present embodiment describes a process of controlling a driving assistance function in S130 shown in FIG. 2.

In S200, a processor 170 of FIG. 1 may identify whether a command to activate a first driving assistance function, a second driving assistance function, or a parking assistance function is received from an input device 120 of FIG. 1, while performing autonomous driving control. When a button assigned the first driving assistance function, the second driving assistance function, or the parking assistance function is input by a user (or a driver), the processor 170 may recognize it through the input device 120.

When receiving the command is received, in S210, the processor 170 may output information indicating that it is impossible to activate the first driving assistance function, the second driving assistance function, or the parking assistance function. The processor 170 may output a notification indicating that it is impossible to activate the function requested to be activated by the user (i.e., it is impossible to switch the function) through an output device 130 of FIG. 1. The output device 130 may output the notification in the form of at least one of visual information, audible information, tactile information, or the like.

In S220, the processor 170 may output the information indicating that it is impossible to activate the function and may perform autonomous driving control. The processor 170 may maintain the autonomous driving function without switching the autonomous driving function to the first driving assistance function, the second driving assistance function, or the parking assistance function.

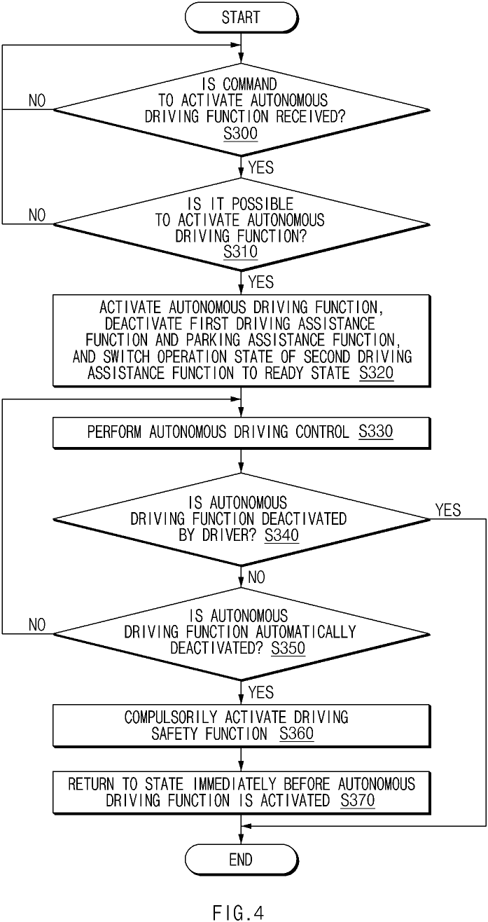

FIG. 4 is a flowchart illustrating a control method of an autonomous vehicle according to another embodiment of the present disclosure.

In S300, a processor 170 of FIG. 1 may identify whether a command to activate an autonomous driving function is received. The processor 170 may receive a control command (or a user input) to instruct to activate the autonomous driving function from an input device 120 of FIG. 1.

In S310, the processor 170 may determine whether it is possible to activate the autonomous driving function. The processor 170 may determine a vehicle state based on information obtained by a detector 110 of FIG. 1 and may determine whether it is possible to activate the autonomous driving function based on the determined result.

When it is determined that it is possible to activate the autonomous driving function, in S320, the processor 170 may activate the autonomous driving function, may deactivate a first driving assistance function and a parking assistance function, and may switch an operation state of a second driving assistance function to a ready state. The autonomous driving function may include the first driving assistance function and may fail to include the second driving assistance function and the parking assistance function.

When the autonomous driving function is activated, in S330, the processor 170 may perform autonomous driving control. The processor 170 may recognize a driving environment, a vehicle state, and the like by means of the detector 110 and may control autonomous driving of a vehicle 100 of FIG. 1 based on the recognized driving environment, the recognized vehicle state, and the like. The processor 170 may perform autonomous driving control using a well-known autonomous driving control technology. Thus, a detailed description of the autonomous driving control will be omitted in the specification.

In S340, the processor 170 may identify whether the autonomous driving function is deactivated by a driver while performing the autonomous driving control. The processor 170 may identify whether a command to instruct to deactivate the autonomous driving function is received from the input device 120 in the state where the autonomous driving function is activated.

When the autonomous driving function is not deactivated by the driver, in S350, the processor 170 may identify whether the autonomous driving function is automatically deactivated. When corresponding to at least one of when there is no user response to a take-over request, when it is impossible to perform the autonomous driving control, or when a system determines to deactivate autonomous driving, the processor 170 may deactivate the autonomous driving function.

When the autonomous driving function is automatically deactivated, in S360, the processor 170 may compulsorily activate a driving safety function. The driving safety function may include at least one of safety assistance functions such as a lane keeping assist function and a collision-avoidance assist function. When the driving safety function includes two or more safety assistance functions, the processor 170 may compulsorily activate at least one of the two or more safety assistance functions. The processor 170 may maintain the driving safety function in an active state, immediately before the autonomous driving function is deactivated by a user, before the user manipulates a steering device, a braking device, or an acceleration device, or during a predetermined specific time.

When the autonomous driving function is deactivated, in S370, the processor 170 may return operation states of the first driving assistance function, the second driving assistance function, and the parking assistance function to a state immediately before the autonomous driving function is activated. For example, when the first driving assistance function is in the active state before the autonomous driving function is activated, the processor 170 may automatically switch the operation state of the first driving assistance function from an inactive state to the active state, when the autonomous driving function is deactivated.

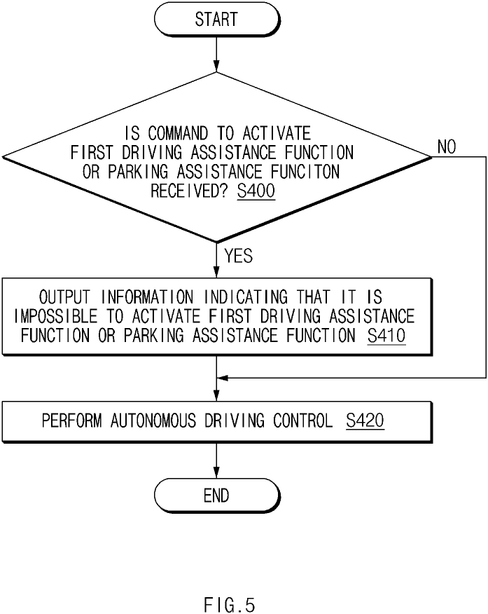

FIG. 5 is a flowchart illustrating an example of controlling a driving assistance function during autonomous driving according to another embodiment of the present disclosure.

In S330 of FIG. 4, a processor 170 of FIG. 1 may identify whether a command to activate a first driving assistance function or a parking assistance function is received in S400. The processor 170 may perform autonomous driving control and may receive a function activation command for the first driving assistance function or the parking assistance function from an input device 120 of FIG. 1.

When the function activation command is received, in S410, the processor 170 may output information indicating that it is impossible to activate the first driving assistance function or the parking assistance function. When receiving a command to activate the first driving assistance function, the processor 170 may output a notification indicating that it is impossible to activate the first driving assistance function to an output device 130 of FIG. 1. Furthermore, when receiving a command to activate the parking assistance function, the processor 170 may output a notification indicating that it is impossible to activate the parking assistance function to the output device 130. The output device 130 may output the notification in the form of at least one of a visual signal, an audible signal, or a tactile signal depending on a control command of the processor 170, such that the user recognizes the notification.

In S420, the processor 170 may output the information indicating that it is impossible to activate the function and may perform autonomous driving control. Although the user inputs the command to activate the first driving assistance function or the parking assistance function, the processor 170 may maintain the autonomous driving function without switching the autonomous driving function to the first driving assistance function or the parking assistance function.

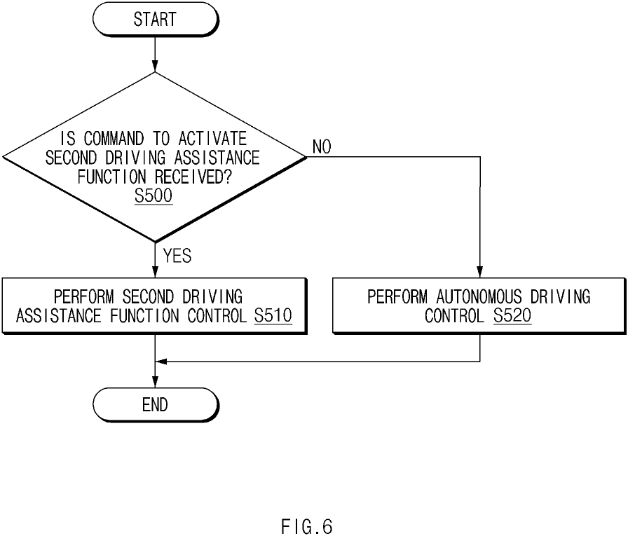

FIG. 6 is a flowchart illustrating another example of controlling a driving assistance function during autonomous driving according to another embodiment of the present disclosure.

In S330 of FIG. 4, a processor 170 of FIG. 1 may identify whether a command to activate a second driving assistance function is received in S500. The processor 170 may receive a control command requesting to activate the second driving assistance function from an input device 120 of FIG. 1.

When the command to activate the second driving assistance function is received, in S510, the processor 170 may perform second driving assistance function control. When receiving the command to activate the second driving assistance function, the processor 170 may switch an operation state of the second driving assistance function from a ready state to an active state. In other words, when a button assigned to turn on and off the second driving assistance function in the input device 120 is input by a user, the processor 170 may switch an autonomous driving function to the second driving assistance function.

When the command to activate the second driving assistance function is not received, in S520, the processor 170 may perform autonomous driving control. When activation of the second driving assistance function is not requested by the user, the processor 170 may maintain the autonomous driving control.

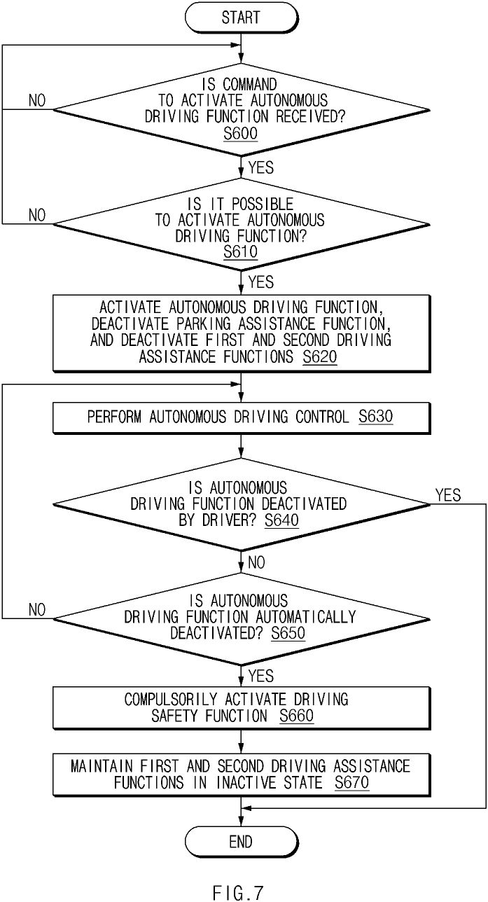

FIG. 7 is a flowchart illustrating a control method of an autonomous vehicle according to another embodiment of the present disclosure.

In S600, a processor 170 of FIG. 1 may identify whether a command to activate an autonomous driving function is received. The processor 170 may receive a control command (or a user input) to instruct to activate the autonomous driving function from an input device 120 of FIG. 1.

In S610, the processor 170 may determine whether it is possible to activate the autonomous driving function. The processor 170 may determine a vehicle state based on information obtained by a detector 110 of FIG. 1 and may determine whether it is possible to activate the autonomous driving function based on the determined result.

When it is determined that it is possible to activate the autonomous driving function, in S620, the processor 170 may activate the autonomous driving function and may deactivate a first driving assistance function, a second driving assistance function, and a parking assistance function The autonomous driving function may include the first driving assistance function and the second driving assistance function and may fail to include the parking assistance function.

When the autonomous driving function is activated, in S630, the processor 170 may perform autonomous driving control. The processor 170 may recognize a driving environment, a vehicle state, and the like by means of the detector 110 and may control autonomous driving of a vehicle 100 of FIG. 1 based on the recognized driving environment, the recognized vehicle state, and the like. The processor 170 may perform autonomous driving control using a well-known autonomous driving control technology. Thus, a detailed description of the autonomous driving control will be omitted in the specification.

In S640, the processor 170 may identify whether the autonomous driving function is deactivated by a driver while performing the autonomous driving control. The processor 170 may identify whether a command to instruct to deactivate the autonomous driving function is received from the input device 120 in the state where the autonomous driving function is activated.

When the autonomous driving function is not deactivated by the driver, in S650, the processor 170 may identify whether the autonomous driving function is automatically deactivated. When corresponding to at least one of when there is no user response to a take-over request, when it is impossible to perform the autonomous driving control, or when a system determines to deactivate autonomous driving, the processor 170 may deactivate the autonomous driving function.

When the autonomous driving function is automatically deactivated, in S660, the processor 170 may compulsorily activate a driving safety function. The driving safety function may include at least one of safety assistance functions such as a lane keeping assist function and a collision-avoidance assist function. When the driving safety function includes two or more safety assistance functions, the processor 170 may compulsorily activate at least one of the two or more safety assistance functions. The processor 170 may maintain the driving safety function in an active state, immediately before the autonomous driving function is deactivated by a user, before the user manipulates a steering device, a braking device, or an acceleration device, or during a predetermined specific time.

After performing S660 or when the autonomous driving function is deactivated by the driver in S640, in S670, the processor 170 may maintain operation states of the autonomous driving function, the first driving assistance function, and the second driving assistance function in an inactive state. When the autonomous driving function is deactivated, the processor 170 may maintain an operation state of a parking assistance function in the inactive state. Although the autonomous driving function is deactivated, the processor 170 may maintain the operation state of the changed function when activating the autonomous driving function. For example, when the operation state of the second driving assistance function switches from the active state to the inactive state when activating the autonomous driving function, the processor 170 may maintain the second driving assistance function in the inactive state when the autonomous driving function is deactivated.

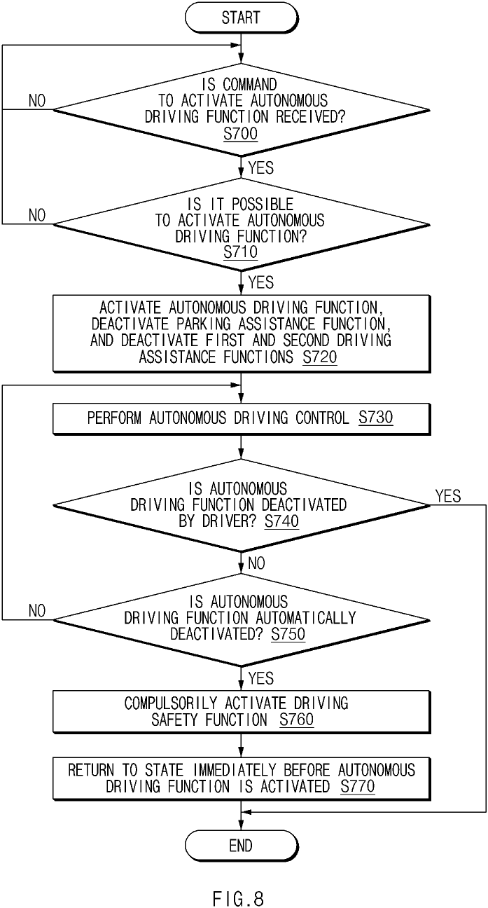

FIG. 8 is a flowchart illustrating a control method of an autonomous vehicle according to another embodiment of the present disclosure.

In S700, a processor 170 of FIG. 1 may identify whether a command to activate an autonomous driving function is received. The processor 170 may receive a control command (or a user input) to instruct to activate the autonomous driving function from an input device 120 of FIG. 1.

In S710, the processor 170 may determine whether it is possible to activate the autonomous driving function. The processor 170 may determine a vehicle state based on information obtained by a detector 110 of FIG. 1 and may determine whether it is possible to activate the autonomous driving function based on the determined result.

When it is possible to activate the autonomous driving function, in S720, the processor 170 may activate the autonomous driving function and may deactivate a first driving assistance function, a second driving assistance function, and a parking assistance function. The autonomous driving function may include the first driving assistance function and the second driving assistance function and may fail to include the parking assistance function.

When the autonomous driving function is activated, in S730, the processor 170 may perform autonomous driving control. The processor 170 may recognize a driving environment, a vehicle state, and the like by means of the detector 110 and may control autonomous driving of a vehicle 100 of FIG. 1 based on the recognized driving environment, the recognized vehicle state, and the like. The processor 170 may perform autonomous driving control using a well-known autonomous driving control technology. Thus, a detailed description of the autonomous driving control will be omitted in the specification.

In S740, the processor 170 may identify whether the autonomous driving function is deactivated by a driver while performing the autonomous driving control. The processor 170 may identify whether a command to instruct to deactivate the autonomous driving function is received from the input device 120 in the state where the autonomous driving function is activated.

When the autonomous driving function is not deactivated by the driver, in S750, the processor 170 may identify whether the autonomous driving function is automatically deactivated. When corresponding to at least one of when there is no user response to a take-over request, when it is impossible to perform the autonomous driving control, or when a system determines to deactivate autonomous driving, the processor 170 may deactivate the autonomous driving function.

When the autonomous driving function is automatically deactivated, in S760, the processor 170 may compulsorily activate a driving safety function. The driving safety function may include at least one of safety assistance functions such as a lane keeping assist function and a collision-avoidance assist function. When the driving safety function includes two or more safety assistance functions, the processor 170 may compulsorily activate at least one of the two or more safety assistance functions based on priorities. The processor 170 may maintain the driving safety function in an active state, immediately before the autonomous driving function is deactivated by a user, before the user manipulates a steering device, a braking device, or an acceleration device, or during a predetermined specific time.

When the autonomous driving function is deactivated, in S770, the processor 170 may return operation states of the first driving assistance function, the second driving assistance function, and the parking assistance function to a state immediately before the autonomous driving function is activated. For example, when the first driving assistance function is in the active state before the autonomous driving function is activated, the processor 170 may automatically switch the operation state of the first driving assistance function from an inactive state to the active state, when the autonomous driving function is deactivated.

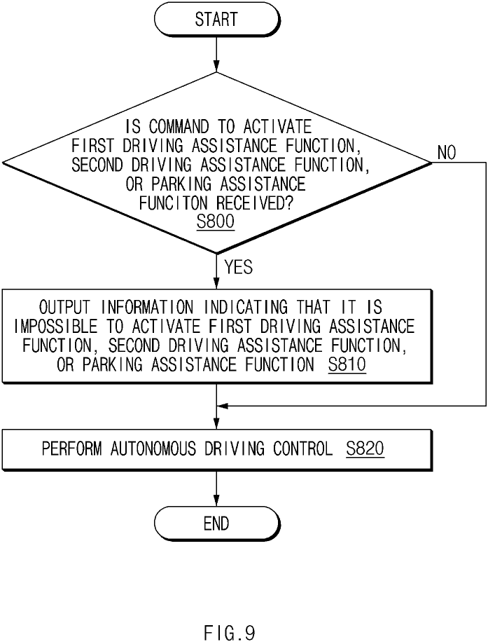

FIG. 9 is a flowchart illustrating a method for controlling a driving assistance function during autonomous driving according to another embodiment of the present disclosure.

In S630 of FIG. 7 or S730 of FIG. 8, a processor 170 of FIG. 1 may perform autonomous driving control and may identify whether a command to activate a first driving assistance function, a second driving assistance function, or a parking assistance function is received from an input device 120 of FIG. 1 in S800. When a button assigned the first driving assistance function, the second driving assistance function, or the parking assistance function is input by a user, the processor 170 may recognize it through the input device 120.

When the command is received, in S810, the processor 170 may output information indicating that it is impossible to activate the first driving assistance function, the second driving assistance function, or the parking assistance function. The processor 170 may output a notification indicating that it is impossible to activate the function requested to be activated by the user (i.e., it is impossible to switch the function) through an output device 130 of FIG. 1. The output device 130 may output the notification in the form of at least one of visual information, audible information, tactile information, or the like.

In S820, the processor 170 may output the information indicating that it is impossible to activate the function and may perform autonomous driving control. The processor 170 may maintain the autonomous driving function without switching the autonomous driving function to the first driving assistance function, the second driving assistance function, or the parking assistance function.

Embodiments of the present disclosure may provide cooperative control of a function having the same control range and a function having a different control function, when an autonomous driving function is activated.

Furthermore, embodiments of the present disclosure may reactivate deactivated functions when activating the autonomous driving function, when the autonomous driving function switches from an active state to an inactive state.

Furthermore, embodiments of the present disclosure may ensure stability of an autonomous driving system by compulsorily activating a driving safety function when the autonomous driving function is deactivated.

Furthermore, embodiments of the present disclosure may safely deliver vehicle control authority to the driver by compulsorily activating a driving safety function when the autonomous driving function is deactivated when it is impossible to perform control authority transition of the driver or due to serious vehicle breakdown.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims. Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An autonomous vehicle, comprising:
a processor configured to perform autonomous driving control of a vehicle,
wherein the processor is configured to:
deactivate a first driving assistance function, when activating an autonomous driving function,
activate a driving safety function, when the autonomous driving function is deactivated during the autonomous driving control, and
return the first driving assistance function to a state before the autonomous driving function is activated.

2. The autonomous vehicle of claim 1, wherein the autonomous driving function includes only functionality of the first driving assistance function or includes functionality of the first driving assistance function and a second driving assistance function and does not include a parking assistance function.

3. The autonomous vehicle of claim 2, wherein the processor is configured to:
receive a command to instruct to activate the first driving assistance function, the second driving assistance function, or the parking assistance function, and
output a notification indicating that it is impossible to activate the first driving assistance function, the second driving assistance function, or the parking assistance function depending on the received command.

4. The autonomous vehicle of claim 2, wherein the processor is configured to:
switch an operation state of the second driving assistance function to a ready state when activating the autonomous driving function, when the autonomous driving function includes only the functionality of the first driving assistance function, and
deactivate the parking assistance function.

5. The autonomous vehicle of claim 4, wherein the processor is configured to:
receive a command to instruct to activate the second driving assistance function, and
switch the operation state of the second driving assistance function from the ready state to an active state.

6. The autonomous vehicle of claim 2, wherein the processor is configured to deactivate the second driving assistance function and the parking assistance function, when activating the autonomous driving function.

7. The autonomous vehicle of claim 1, wherein when the autonomous driving function is deactivated is at least one of when there is no user response to a take-over request, when it is impossible to perform the autonomous driving control, or when a system determines to deactivate autonomous driving.

8. The autonomous vehicle of claim 1, wherein the processor is configured to maintain activation of the driving safety function, before the autonomous driving function is deactivated by a user, when the user manipulates a steering device, a braking device, or an acceleration device, or during a predetermined specific time.

9. The autonomous vehicle of claim 1, wherein the processor is configured to activate at least one driving safety function depending on a priority, when there are two or more driving safety functions.

10. The autonomous vehicle of claim 1, wherein the processor is configured to maintain the autonomous driving function and the first driving assistance function in an inactive state, when the autonomous driving function is deactivated.

11. A control method of an autonomous vehicle, the control method comprising:
deactivating, by a processor, a first driving assistance function, when activating an autonomous driving function;
performing, by the processor, autonomous driving control in a state where the autonomous driving function is activated;
activating, by the processor, a driving safety function, when the autonomous driving function is deactivated; and
returning, by the processor, the first driving assistance function to a state before the autonomous driving function is activated, when the autonomous driving function is deactivated.

12. The control method of claim 11, wherein the autonomous driving function includes only functionality of the first driving assistance function or includes functionality of the first driving assistance function and a second driving assistance function and does not include a parking assistance function.

13. The control method of claim 12, wherein the performing of the autonomous driving control includes:
receiving, by the processor, a command to instruct to activate at least one of the first driving assistance function, the second driving assistance function, or the parking assistance function; and
outputting, by the processor, a notification indicating that it is impossible to activate the first driving assistance function, the second driving assistance function, or the parking assistance function depending on the received command.

14. The control method of claim 12, wherein the deactivating of the first driving assistance function includes:
switching, by the processor, an operation state of the second driving assistance function to a ready state, when the autonomous driving function includes only the functionality of the first driving assistance function; and
deactivating, by the processor, the parking assistance function.

15. The control method of claim 14, wherein the performing of the autonomous driving control includes:
receiving, by the processor, a command to instruct to activate the second driving assistance function; and
switching, by the processor, the operation state of the second driving assistance function from the ready state to an active state.

16. The control method of claim 12, wherein the deactivating of the first driving assistance function includes:
deactivating, by the processor, the second driving assistance function and the parking assistance function.

17. The control method of claim 11, wherein when the autonomous driving function is deactivated is at least one of when there is no user response to a take-over request, when it is impossible to perform the autonomous driving control, or when a system determines to deactivate autonomous driving.

18. The control method of claim 11, wherein the activating of the driving safety function includes:
maintaining, by the processor, activation of the driving safety function, before the autonomous driving function is deactivated by a user, when the user manipulates a steering device, a braking device, or an acceleration device, or during a predetermined specific time.

19. The control method of claim 11, wherein the activating of the driving safety function includes:
activating, by the processor, at least one driving safety function depending on a priority, when there are two or more driving safety functions.

20. The control method of claim 11, further comprising:
maintaining, by the processor, the autonomous driving function and the first driving assistance function in an inactive state, when the autonomous driving function is deactivated.
